(19) United States
(12) Patent Application Publication
(10) Pub. No.: US 2015/0277608 A1
(43) Pub. Date: Oct. 1, 2015

(54) METHOD FOR CARRYING OUT EDGE ETCHING AND STRENGTHENING OF CUT ONE-GLASS-SOLUTION TOUCH PANEL WITH ONE-TIME FILM LAMINATION

(71) Applicant: GHITRON TECHNOLOGY CO., LTD., Hsinchu 310 (TW)

(72) Inventor: CHUN-YUAN LEE, HSINCHU 310 (TW)

(21) Appl. No.: 14/640,286

(22) Filed: Mar. 6, 2015

(30) Foreign Application Priority Data
Mar. 28, 2014 (TW) 103111593

(51) Int. Cl. G06F 3/041

(52) U.S. Cl. CPC G06F 3/041

(57) ABSTRACT

A method for carrying out edge etching and strengthening of a cut one-glass-solution (OGS) touch panel with one-time film lamination is disclosed. A large-sized glass panel, after subjected to strengthening treatment and forming touch control circuits and edge frames thereon, is cut to form small-sized glass panel units. An upper lamination film and a lower lamination film are respectively laminated on surfaces of each of the small-sized glass panel units and portions of the upper and lower lamination films are out so as to form film cutting lines between the cutting zones and the edge frame. The portions of the upper and lower lamination films of each of the small-sized glass panel units corresponding to the cutting zones are peeled off along the film cutting line so as to leave portions of the upper and lower lamination films corresponding to the touch control circuit and the edge frame. Finally, the small-sized glass panel units are each subjected to etching and strengthening along side edges thereof.

### BACKGROUND OF THE INVENTION

1. Field of the Invention

The present invention relates to a manufacturing process of a one-glass-solution (OGS) touch panel, and in particular to a method for carrying out edge etching and strengthening of a cut one-glass-solution (OGS) touch panel with one-time film lamination.

2. The Related Arts

With the widening of the application of touch panels, there are more and more electronic products that adopt touch panels as an input measure to provide a simple and intuitive interface operation mode. The known touch panels are generally classified as a resistive type, a capacitive type, and an optic type, according to the operations thereof, among which the capacitive type has excellent vantage in supporting the function of multi-touch and is gaining the favor of the market for being widely used in contemporary electronic products.

The conventional capacitive touch panel generally comprises two conductive layers between which spacers and electrodes are arranged. A surface layer is generally composed of a polyester plastic sheet of which an inside surface is provided with a conductive metal film; and a bottom layer is composed of a glass substrate containing a conductive material. The glass substrate and the polyester sheet are spaced from each other by a minute spacer layer comprising even tinier polyester plastic made spacers arranged therebetween and a plurality of division lines is formed. These division lines extend along the glass substrate to define an X-axis, while the polyester sheet forms a Y-axis. When a finger tip or a pen tip pressurizes the touch screen, an electronic controller beside the conductive layers detects the X coordinate and the Y coordinate of the touch point and reflects it on the screen.

Due to the demand of the consumer market for a lighter and thinner outside appearance of the electronic products, the thickness of a final product of a touch panel is reduced by using a one-glass-solution (OGS) manufacturing process that eliminates one transparent substrate and arranges X-axis and Y-axis touch wires and side frames directly on a single glass substrate and thus space required for the assembly of an electronic product can be reduced and the need for making the outside appearance of an electronic product lighter and thinner can be met. The one-glass-solution, which is also referred to as touch on lens is the main stream of all the touch panels available in the market. The OGS has vantages in cost and manufacture and satisfies the demand of the electronic technology for a lighter and thinner outside appearance, and has thus been used by international mobile phone and tablet computer manufacturers.

The OGS touch panel is structured by combining a touch glass panel and a protection glass panel as a single glass sheet with touch sensors directly formed on the protection glass panel so that touch function of a touch glass panel and the strength of the protection glass panel are integrated on a single glass sheet.

In the manufacture, a single glass sheet touch panel is first subjected to operations of film lamination and strengthening and is then cut. Although such a process allows for cutting a large-sized single glass sheet touch panel into small-sized single glass sheet touch panels, machines required for such a process requires are large-sized machinery that occupies an extremely large amount of space and the lay out of a workshop is subjected to certain limitations. Further, a strengthened piece of glass is hard to cut or split for the strengthened glass has higher rigidity than regular glass. Wear and loss of the cutting tool are severe so that cost for the cutting is high and the yield rate is low. In addition, edges of the strengthened glass may get cracking during the cutting process, resulting in micro cracks in the edges of the glass. Such cracks greatly lowers down the strength of the glass and consequently, defect product may result. Some known manufacturing processes overcomes such problems by first cutting and then strengthening, and subsequently carrying out film lamination and etching and strengthening. Such a solution, however, is of low efficiency and a high cost for mass production.

### SUMMARY OF THE INVENTION

In view of the above drawbacks of the manufacture of a one-glass-solution (OGS) touch panel, a primary object of the present invention is to provide a single lamination based after-cutting OGS etching and strengthening method, which allows for manufacture of a touch panel through a single lamination operation.

To achieve the above object, the present invention provides a manufacturing process, which comprises subjecting a large-sized glass panel to a first strengthening treatment, then forming a plurality of touch control circuits and edge frames respectively corresponding to the touch control circuits on a surface of the large-sized glass panel so as to define a plurality of cutting zones and preserved zones, cutting the large-sized glass panel along the cutting zones to form a plurality of small-sized glass panel units comprising a portion of the cutting zones, laminating an upper lamination film and a lower lamination film to surfaces of the small-sized glass panel units, cutting portions of the upper lamination film and the lower lamination film corresponding to the cutting zones to form film cutting lines, peeling the portions of the films corresponding to the cutting zones along film cutting lines, and subjecting each of the small-sized glass panel units to grinding of side edges thereof, and after the grinding of the side edges of the small-sized glass panel units. subjecting the small-sized glass panel units to operations of hole drilling and etching and strengthening.

The feature of the present invention is that only one step of film lamination is involved, wherein after a large-sized glass panel is cut to form small-sized glass panel units, the single film lamination operation is applied to laminate the films, following by cutting through a specific way. After the cutting the portions of the films within a preservation zone are kept for being actively used in the subsequent operations. Such a process can be carried out with small-sized machines so that the workshop lay out can be arranged to install multiple production lines with multiple small-sized machines to increase the throughput.

The single lamination based after-cutting OGS etching and strengthening method according to the present invention requires no film lamination to be done in each of the steps of the process so that the process is simplified and the potential risks of scratching and contaminating the touch glass occurring in the operations of film replacement can be reduced, and the great investment of facility cost and the processing time for multiple times of film replacement can both be reduced.

The manufacturing process of the present invention divides the strengthening operation into two separate steps and reduces the depth of strengthening made in each of the first strengthening treatments so that the difficulty of cutting can be alleviated to prevent the formation of cracking. And, the strength is further improved through etching and strengthening conducted after the cutting.

### BRIEF DESCRIPTION OF THE DRAWINGS

The present invention will be apparent to those skilled in the art by reading the following description of preferred embodiments of the present invention, with reference to the attached drawings, in which:

FIG. 1 is a flow chart illustrating a manufacturing method according to the present invention;

FIG. 2 is a perspective view showing a large-sized glass panel;

FIG. 3 is a schematic perspective view illustrating the arrangement of a plurality of touch control circuits and edge frames on a second surface of the large-sized glass panel according to the present invention;

FIG. 4 is a cross-sectional view taken along line 4-4 of FIG. 3;

FIG. 5 is a schematic view illustrating cutting the large-sized glass panel into small-sized glass panel units along cutting zones;

FIG. 6 is a schematic view illustrating laminating an upper lamination film and a lower lamination film respectively on first and second surfaces of a small-sized glass panel unit;

FIG. 7 is a schematic view illustrating film cutting conducted along the cutting zones so as to form film cutting lines in the cutting zones;

FIG. 8 is a schematic view illustrating removing portions of the lamination films from the cutting zones with a preserved portion of the upper lamination film left on the first surface of the small-sized glass panel unit and a preserved portion of the lower lamination film left on the second surface;

FIG. 9 is a schematic view illustrating grinding side edges of the small-sized glass panel unit; and

FIG. 10 is a cross-sectional view showing a single one of the small-sized glass panel units after removal of the upper lamination film and the lower lamination film.

### DETAILED DESCRIPTION OF THE PREFERRED EMBODIMENTS

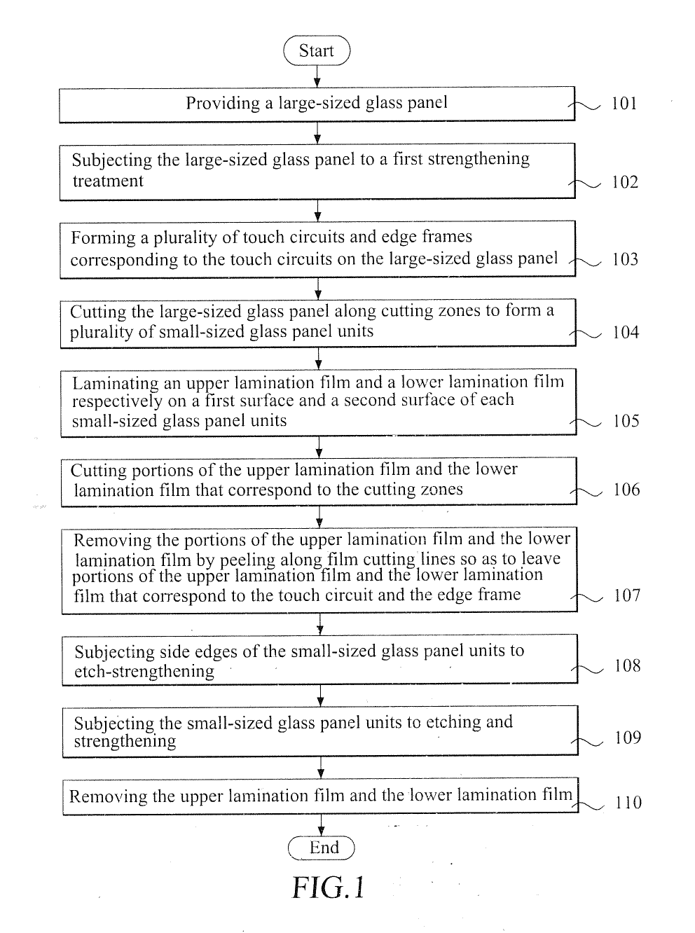

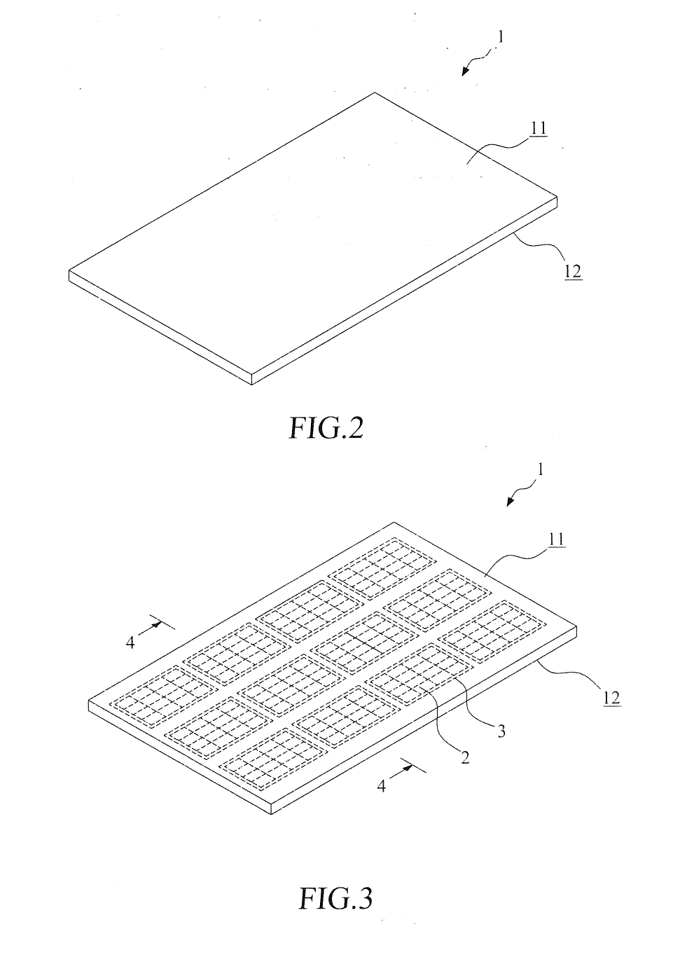

With reference to the drawings and in particular to FIGS. 1-10, to practice a manufacturing process according to the present invention, a large-sized glass panel 1 is first prepared (Step 101). The large-sized glass panel 1 comprises a first surface 11 and a second surface 12 (as shown in FIG. 2), wherein the first surface 11 provides a user operation surface for a touch function of a product, while the second surface 12 provides a surface for laying wiring.

Referring to Step 102, next, the large-sized glass panel 1 is subjected to a first strengthening treatment. To carry out the strengthening treatment, one of chemical strengthening and physical strengthening that are well known can be used to increase the glass hardness of the large-sized glass panel 1. Taking chemical strengthening as an example, generally, the large-sized glass panel 1 is subjected to ion exchange with sodium or potassium ions at a high temperature of 450-500 degree Celsius in order to increase the glass hardness.

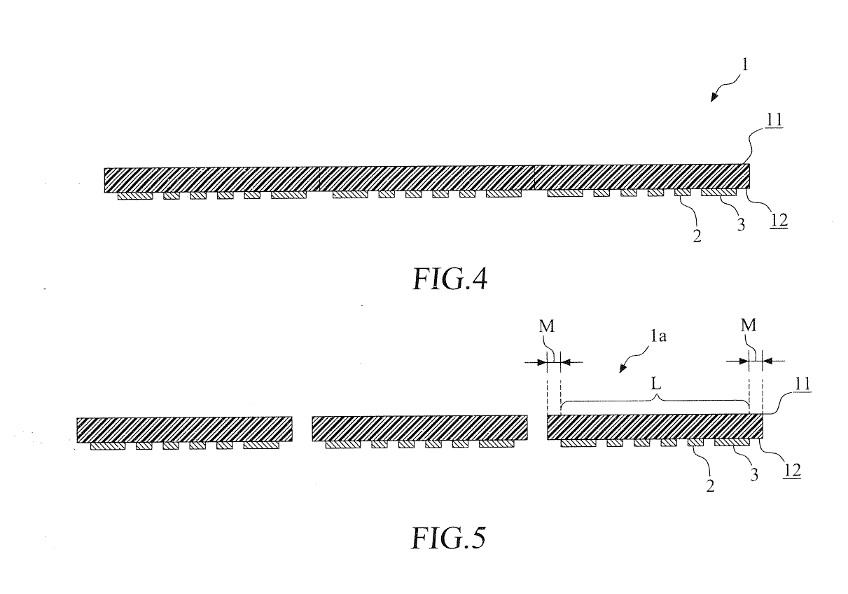

Referring to Step 103 and FIGS. 3 and 4, after the first strengthening treatment is completed, a plurality of touch control circuits 2 and edge frames 3 respectively corresponding to the touch control circuits 2 are formed on the second surface 12 of the large-sized glass panel 1 so as to define a plurality of preserved zones L and the cutting zones M on the large-sized glass panel 1, wherein the preserved zones L each comprises the area covering one of the touch control circuit 2 and the corresponding edge frame 3. The area between two adjacent ones of the edge frames 3 is defined as a cutting zone M. The edge frames 3 can be black, white, or other color edge frames.

Referring to Step 104 and FIG. 5, the large-sized glass panel 1 is subjected to cutting made along the cutting zones M to split the large-sized glass panel 1 into a plurality of small-sized glass panel units 1a. Each of the small-sized glass panel units 1a comprises one of the touch control circuits 2 and the corresponding edge frame 3 and a portion of the cutting zones M.

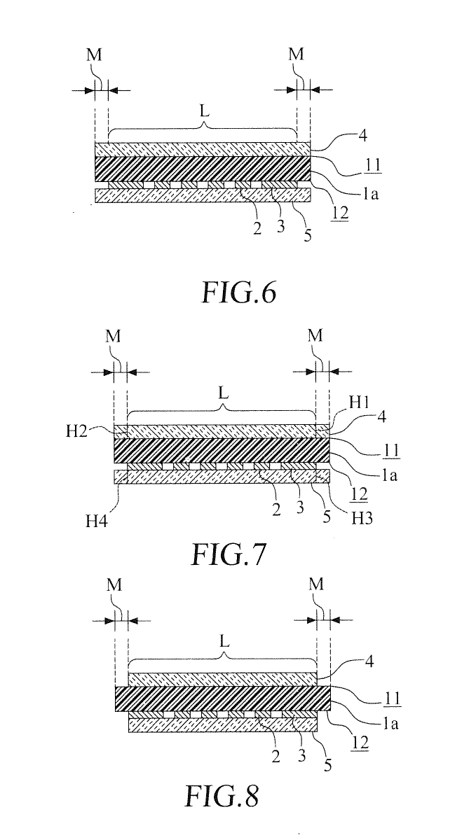

Referring to Step 105 and FIG. 6, an upper lamination film 4 and a lower lamination film 5 are respectively laminated on a first surface 11 and a second surface 12 of each of the small-sized glass panel units 1a. The upper lamination film 4 and the lower lamination film 5 are made of materials that comprise acidic corrosion resistant materials so as to protect the glass surfaces from scratching and to provide an effect of glass protection for etching and strengthening in the subsequent operations.

Referring to Step 106 and FIG. 7, partial areas of the upper lamination film 4 and the lower lamination film 5 that correspond to the cutting zones M are subjected to cutting made along the cutting zones M of each of the small-sized glass panel units 1a so as to form film cutting lines H1, H2, H3, H4 between the cutting zones M and the edge frame 3. The cutting of the film can be achieved with laser, stamping, cutter die that is applied along the cutting zones to cut the upper lamination film 4 and the lower lamination film 5.

Referring to Step 107 and FIG. 8, the portions of the upper lamination film 4 and the lower lamination film 5 of each of the small-sized glass panel units 1a are peeled off along the film cutting lines H1, H2, H3, H4 so as to remove the portions of the upper lamination film 4 and the lower lamination film 5 corresponding to the cutting zones M, but leave portions of the upper lamination film 4 and the lower lamination film 5 that correspond to the touch control circuits 2 and the edge frame 3.

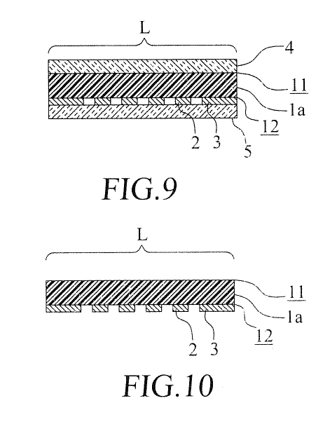

Referring to Steps 108, 109, and 110 and FIGS. 9 and 10, side edges of each of the small-sized glass panel units 1a are subjected to etching and strengthening by grinding the edges of the small-sized glass panel unit 1a and, after the edge grinding, hole drilling is conducted in the small-sized glass panel unit 1a. After the edge grinding and hole drilling of the small-sized glass panel unit 1a, the small-sized glass panel units 1a is subjected to etching for strengthening. Etching the side edges of the small-sized glass panel unit 1a may remove micro cracks and invisible crack in the side edges of the glass panel so as to achieve secondary strengthening, edge polishing, and edge smoothening for the small-sized glass panel unit thereby achieving a desired product strength for the small-sized glass panel units 1a (as shown in FIG. 9). After the etching and strengthening, the upper lamination film 4 and the lower lamination film 5 are peeled off and removed (as shown in FIG. 10).

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for carrying out edge etching and strengthening of a cut one-glass-solution (OGS) touch panel, comprising the following steps:
(a) providing a large-sized glass panel;
(b) subjecting the large-sized glass panel to a first strengthening treatment;
(c) forming a plurality of touch control circuits and edge frames respectively corresponding to the touch control circuits on the large-sized glass panel, adjacent ones of the edge frames being spaced by an area therebetween that serves as a cutting zone;
(d) cutting the large-sized glass panel along the cutting zones to form a plurality of small-sized glass panel units, wherein each of the small-sized glass panel units comprises one of the touch control circuits, the corresponding edge frame, and a portion of the cutting zone;
(e) laminating an upper lamination film and a lower lamination film respectively on a first surface and a second surface of each of the small-sized glass panel units;
(f) cutting portions of the upper lamination film and the lower lamination film that correspond to the cutting zones along the cutting zones of each of the small-sized glass panel units so as to form film cutting lines between the cutting zones and the edge frame;
(g) removing the portions of the upper lamination film and the lower lamination film of each of the small-sized glass panel units corresponding to the cutting zones by peeling along the film cutting lines so as to leave portions of the upper lamination film and the lower lamination film that correspond to the touch control circuit and the edge frame; and
(h) subjecting side edges of each of the small-sized glass panel units to etching and strengthening.

2. The method as claimed in claim 1, wherein in step (e), the upper lamination film and the lower lamination film are made of an acidic corrosion resistant material.

3. The method as claimed in claim 1, wherein in step (f), one of laser, stamping, and cutting die is applied to cut the upper lamination film and the lower lamination film along the cutting zones.

4. The method as claimed in claim 1 further comprising a step of grinding side edges of the small-sized glass panel units before step (h).

5. The method as claimed in claim 4 further comprising a step of hole drilling conducted on the small-sized glass panel unit after the step of edge grinding.

6. The method as claimed in claim 4 further comprising a step of etching conducted on the small-sized glass panel unit after the step of edge grinding.
